(19) United States
(12) Patent Application Publication
(10) Pub. No.: US 2026/0287338 A1
(43) Pub. Date: Sep. 24, 2026

(54) SHAPE MEASURING APPARATUS AND SHAPE MEASURING METHOD

(71) Applicant: Tokyo Seimitsu Co., Ltd., Tokyo (JP)

(72) Inventor: Hideki MORII, Tsuchiura-city (JP)

(73) Assignee: Tokyo Seimitsu Co., Ltd., Tokyo (JP)

(21) Appl. No.: 19/570,470

(22) Filed: Mar. 18, 2026

(30) Foreign Application Priority Data
Mar. 19, 2025 (JP) 2025-045574

(51) Int. Cl. G01B 11/30

(52) U.S. Cl. CPC G01B 11/30

(57) ABSTRACT

A shape measuring apparatus includes: an optical unit having an imaging section configured to capture an image of a surface to be measured; a drive mechanism configured to move the optical unit relative to the surface to be measured in a direction along an optical axis of the imaging section; an illumination section configured to laterally illuminate the surface to be measured and can switch between a point light source function and a surface light source function; a shape data generating section configured to generate shape data indicating a shape of the surface to be measured based on captured images obtained by repeatedly capturing images with the imaging section while the optical unit is relatively moved; and an illumination controlling section configured to switch the illumination section that laterally illuminates the surface to be measured between the point light source function and the surface light source function.

### CROSS-REFERENCE TO RELATED APPLICATIONS

The present application claims priority under 35 U.S.C §119(a) to Japanese Patent Application 2025-045574 filed on March 19, 2025, which is hereby expressly incorporated by reference, in its entirety, into the present application.

### BACKGROUND OF THE INVENTION

### Field of the Invention

The present invention relates to a shape measuring apparatus and a shape measuring method, and particularly to a shape measuring apparatus and a shape measuring method for measuring a shape of a measurement object.

### Description of the Related Art

A shape measuring apparatus captures an image of a surface to be measured of a measurement object and measures a shape of the surface to be measured using the captured image. This shape measuring apparatus uses illumination suitable for properties of a measurement object or for a measurement purpose, when imaging the surface to be measured.

Patent Literature 1 discloses an appearance inspection device which captures an image of a surface of a wafer and detects a defect, such as a flaw (scratch), on the surface of the wafer. The appearance inspection device disclosed in Patent Literature 1 includes: a bevel inspecting section which inspects a bevel portion at an edge portion of a wafer; and an apex inspecting section which inspects an apex portion and the bevel portion. The bevel inspecting section includes an annular illuminator which can irradiate the bevel portion with measurement light from two sides of the wafer, and captures an image of the bevel portion with imaging sections (second imaging sections) arranged to face each other across the wafer. The apex inspecting section includes surface illuminators which can irradiate the apex portion with measurement light from the two sides of the wafer, and captures an image of the apex portion that is an end face portion at an outer periphery of the wafer with an imaging section (third imaging section) on an outer peripheral side of the wafer.

### Citation List

### Patent Literatures

Patent Literature 1: Japanese Patent Application Laid-Open No. 2020-197530

### SUMMARY OF THE INVENTION

As described above, in some cases, oblique illumination (e.g., a ring illuminator) or side illumination may be used when capturing an image of the surface to be measured of the measurement object. In a case where the surface to be measured of the measurement object is an inclined surface inclined with respect to an optical axis of the imaging section, it is preferable to illuminate the inclined surface as uniformly as possible. For example, a surface-emitting light source including a diffuser and the like is used as a device for uniformly illuminating the inclined surface.

A measurement object W shown in FIG. 16 has: a facing surface So which is substantially perpendicular to an optical axis of an imaging section CAM; inclined surfaces SI1 and SI2 which are inclined with respect to the optical axis of the imaging section CAM; and side surfaces SL1 and SL2 which are substantially parallel to the optical axis of the imaging section CAM. To uniformly illuminate the measurement object W, surface-emitting light sources SE1 and SE2 are arranged substantially parallel to the inclined surfaces SI1 and SI2 respectively (oblique illumination), as shown in an example XVIA. Alternatively, the surface-emitting light sources SE1 and SE2 are arranged substantially parallel to the side surfaces SL1 and SL2 respectively (side illumination), as shown in an example XVIB.

When the measurement object W is illuminated using surface-emitting light sources, however, a captured image of the surface to be measured, such as the facing surface So or the inclined surfaces SI1 and SI2, has a reduced contrast. For this reason, it is difficult to find a position of the measurement object (e.g., irregularities, a foreign substance, or a flaw) from the captured image of the surface to be measured.

The present invention has been made in view of the above-described circumstances, and aims to provide a shape measuring apparatus and a shape measuring method capable of applying appropriate illumination according to the properties (characteristics) of the object to be measured or the measurement purpose.

A shape measuring apparatus according to a first aspect of the present invention includes: an optical unit having an imaging section configured to capture an image of a surface to be measured of a measurement object; a drive mechanism configured to move the optical unit relative to the surface to be measured in a direction along an optical axis of the imaging section; an illumination section configured to laterally illuminate the surface to be measured and capable of switching between a point light source function and a surface light source function; a shape data generating section configured to generate shape data indicating a shape of the surface to be measured based on captured images obtained by repeatedly capturing images with the imaging section while the optical unit is relatively moved; and an illumination controlling section configured to switch the illumination section that laterally illuminates the surface to be measured, between the point light source function and the surface light source function.

According to a second aspect of the present invention, in the shape measuring apparatus according to the first aspect, the illumination section includes a plurality of planarly arranged point light sources, in a case where the illumination section is set to perform the point light source function, one point light source of the plurality of point light sources is made to emit light, or two or more point light sources spaced apart by a distance equal to or more than a first spacing are made to emit light, and in a case where the illumination section is set to perform the surface light source function, all of the plurality of point light sources are made to emit light, or two or more point light sources spaced apart by a distance equal to or less than a second spacing narrower than the first spacing, are made to emit light.

According to a third aspect of the present invention, in the shape measuring apparatus according to the second aspect, the illumination section includes a diffuser configured to diffuse light beams from the plurality of point light sources onto the surface to be measured, and an insertion and removal mechanism configured to insert and remove the diffuser into and from a space between the plurality of point light sources and the surface to be measured, and the illumination controlling section removes the diffuser in a case where the illumination section is set to perform the point light source function, and inserts the diffuser in a case where the illumination section is set to perform the surface light source function.

According to a fourth aspect of the present invention, in the shape measuring apparatus according to the third aspect, the illumination section includes a plurality of diffusers different in light diffusion performance.

According to a fifth aspect of the present invention, in the shape measuring apparatus according to the second aspect, the illumination section includes a variable diffuser, light diffusion performance of which is changeable, and in a case where the illumination section is set to perform the surface light source function, the illumination controlling section sets transmittance of the variable diffuser lower than in a case where the illumination section is set to perform the point light source function.

According to a sixth aspect of the present invention, in the shape measuring apparatus according to any one of the first to fifth aspects, the illumination controlling section switches the illumination section to the point light source function when locating a position of an object of measurement.

According to a seventh aspect of the present invention, in the shape measuring apparatus according to the sixth aspect, the illumination controlling section switches the illumination section to the surface light source function in measuring a shape at the position of the object of measurement.

According to an eighth aspect of the present invention, the shape measuring apparatus according to the sixth or seventh aspect, further includes an output device configured to display a live-view image captured by the imaging section when locating the position of the object of measurement.

According to a ninth aspect of the present invention, in the shape measuring apparatus according to any one of the first to eighth aspects, the illumination controlling section switches the illumination section to the point light source function in a case where the surface light source function fails to bring the imaging section into focus on the surface to be measured or in a case where a contrast value of an image captured by the imaging section is equal to or less than a threshold.

According to a tenth aspect of the present invention, in the shape measuring apparatus according to any one of the first to ninth aspects, the illumination controlling section switches between the point light source function and the surface light source function in accordance with an input selecting a type of the measurement object.

A shape measuring method according to an eleventh aspect of the present invention includes: generating shape data indicating a shape of a surface to be measured of a measurement object, based on captured images obtained by repeatedly capturing images of the surface to be measured with an imaging section while the an optical unit, having the imaging section, is moved relative to the surface to be measured in a direction along an optical axis of the imaging section; and switching an illumination section that laterally illuminates the surface to be measured, between a point light source function and a surface light source function.

According to the present invention, it is possible to apply appropriate illumination in accordance with, e.g., properties (characteristics) or a measurement objective of a measurement object by switching an illumination section between a point light source and a surface light source.

### BRIEF DESCRIPTION OF THE DRAWINGS

FIG. 1 is a view showing a shape measuring apparatus according to an embodiment of the present invention;

FIG. 2 is a block diagram showing a processing device of the shape measuring apparatus;

FIG. 3 is a chart for explaining a difference in how contrast information is obtained between a case where point emission is applied to an illumination section and a case where surface emission is applied to the illumination section;

FIG. 4 is a side view showing an example of a surface light source according to Example 1;

FIG. 5 is a side view showing an example of an illumination section according to Example 2;

FIG. 6 is a side view showing an example of an illumination section according to a first modification of Example 2;

FIG. 7 is a side view showing an example of an illumination section according to a second modification of Example 2;

FIG. 8 is a side view showing an example of an illumination section according to a third modification of Example 2;

FIG. 9 is a cross-sectional view showing an example of a variable diffuser;

FIG. 10 is a cross-sectional view showing an example of the variable diffuser;

FIG. 11 is a chart for explaining a first example of illumination control;

FIG. 12 is a flowchart showing the first example of illumination control;

FIG. 13 is a flowchart showing a second example of the illumination control;

FIG. 14 is a flowchart showing a modification of the second example of the illumination control;

FIG. 15 is a flowchart showing a third example of the illumination control;

FIG. 16 is a view showing an example of illuminating a measurement object with surface-emitting light sources.

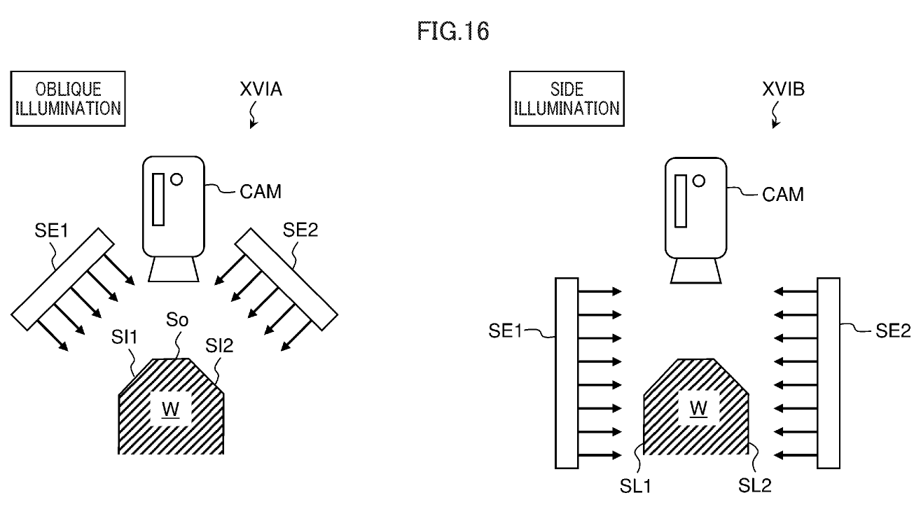

### DESCRIPTION OF THE EMBODIMENTS

An embodiment of the present invention will be described below with reference to the accompanying drawings.

### Shape Measuring Apparatus

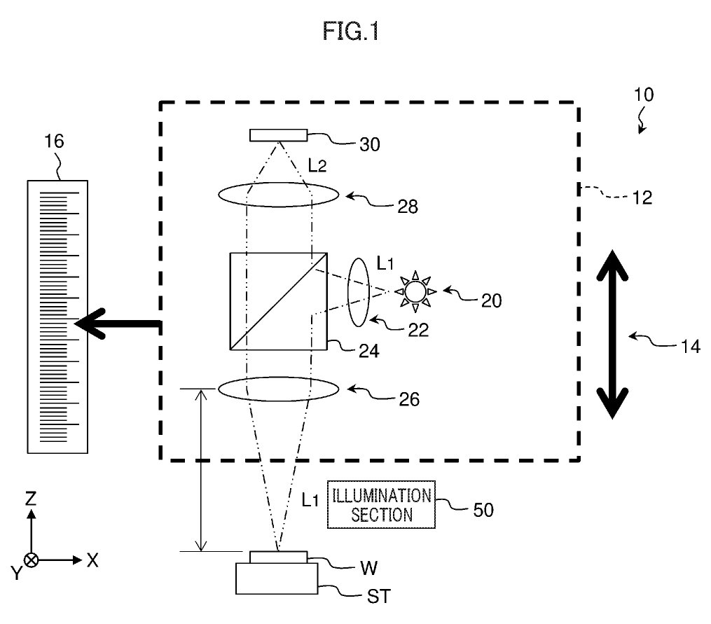

FIG. 1 is a view showing a shape measuring apparatus according to an embodiment of the present invention. In the following description, an XYZ orthogonal coordinate system is used. In the XYZ orthogonal coordinate system, a movement direction (scanning direction) of an optical unit 12 of a shape measuring apparatus 10 is taken as a Z direction.

The shape measuring apparatus 10 includes the optical unit 12, a drive mechanism 14, and a scale 16, and measures a surface to be measured of the measurement object W by a focus variation method (focal-plane scanning method). Specifically, the shape measuring apparatus 10 continuously captures an image of the measurement object W with an imaging section 30 while moving the optical unit 12 in the Z direction with the drive mechanism 14. The shape measuring apparatus 10 detects a Z position at which a contrast of each pixel of the captured image is maximized, thereby acquiring the three-dimensional shape of the surface of the object to be measured W.

The optical unit 12 includes a device for capturing an image of the measurement object W, and is configured to be movable in X, Y, and Z directions with respect to a stage ST on which the measurement object W is placed.

The drive mechanism 14 is a device for moving the optical unit 12 with respect to the stage ST, and includes, for example, a motor.

The scale 16 is a device for measuring a position of the optical unit 12. FIG. 1 shows only a scale for measurement of a Z position. Note that a position detection method in the scale 16 is not limited to reading a graduation on the scale.

Note that means for scanning the measurement object W is not limited to the drive mechanism 14 that moves the optical unit 12 in the Z direction. For example, either the stage ST, on which the measurement object W is placed, or the shape measuring apparatus 10 may be moved. That is, it suffices to move the measurement object W relative to the optical unit 12 of the shape measuring apparatus 10 in the Z direction.

As shown in FIG. 1, the optical unit 12 includes a light source 20, a lens 22, a beam splitter 24, condenser lenses 26 and 28, and the imaging section 30.

The light source 20 is a device which emits measurement light L₁, and includes, for example, a light-emitting diode, a semiconductor laser, a halogen lamp, or a high-intensity discharge lamp (e.g., a xenon lamp). The measurement light L₁ here is, for example, white light. The white light includes light of a wide range of wavelengths (e.g., 380 nm to 780 nm) and is low coherence light that is less coherent.

The lens 22 includes a collector lens which converts the measurement light L₁ emitted from the light source 20 into parallel light.

The beam splitter 24 includes, for example, a half mirror. The beam splitter 24 reflects the measurement light L₁which has been converted into parallel light toward the measurement object W, and transmits reflected light L₂ which is the measurement light L₁reflected from the measurement object W toward the imaging section 30.

The condenser lens 26 on an objective side converges the measurement light L₁reflected by the beam splitter 24 onto the surface to be measured of the measurement object W.

The condenser lens 28 on an imaging side converges the reflected light L₂ which is the measurement light L₁ reflected from the measurement object W, onto an imaging surface of the imaging section 30.

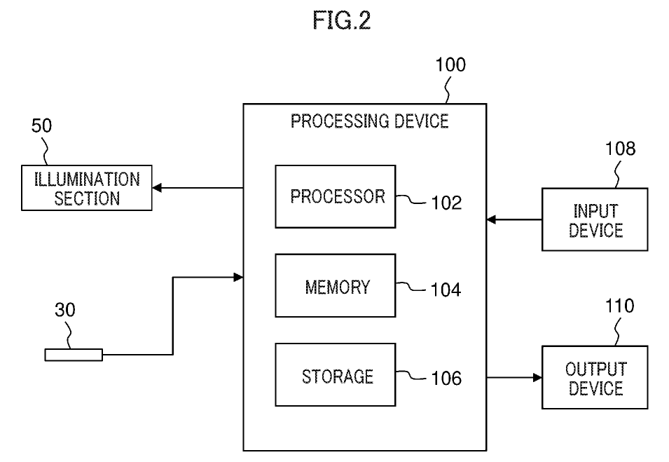

The imaging section (camera) 30 includes an image sensor (e.g., a charge coupled device (CCD)), and is configured to capture the reflected light L₂ to acquire an image. The imaging section 30 captures the reflected light L₂ at each Z position (each reading value of the scale 16) of the optical unit 12. The image captured by the imaging section 30 is transmitted to a processing device 100 (see FIG. 2) of the shape measuring apparatus 10, and processing for three-dimensional shape measurement is performed in the processing device 100.

Note that although coaxial incident illumination is used in the shape measuring apparatus 10, the present invention is not limited to this. Different illumination may be used instead of or in addition to coaxial incident illumination.

An illumination section 50 provides illumination according to, e.g., properties or a measurement objective of the measurement object W when capturing an image of the measurement object W. The illumination section 50 may be configured to be movable integrally with or separately from the optical unit 12. For example, the illumination section 50 may be configured to move following the optical unit 12 with respect to movement of the optical unit 12 in the X, Y, and Z directions. Alternatively, with respect to movement of the optical unit 12 in the Z direction, the illumination section 50 may be configured not to move together with the optical unit 12.

The type of the shape measuring apparatus 10 is not limited to ones that use the focus variation method. The illumination section 50 according to the present application may be applied to an arbitrary shape measuring apparatus that illuminates the measurement object W to capture an image.

FIG. 2 is a block diagram showing the processing device 100 of the shape measuring apparatus 10. As shown in FIG. 2, the processing device 100 of the shape measuring apparatus 10 includes a processor 102, a memory 104, and a storage 106. An input device 108 and an output device 110 are connected to the processing device 100. The processing device 100 may be, for example, a personal computer or a workstation.

The processor 102 includes hardware configured to implement functions described in the present specification. This hardware is, for example, a general-purpose processor, such as a central processing unit (CPU) or a general-purpose graphics processing unit (GPGPU), a programmable logic circuit device, such as a field programmable gate array (FPGA) or a complex programmable logic device (CPLD), or an integrated circuit for specific use, such as an application specific integrated circuit (ASIC), or circuitry including a combination of two or more thereof.

The processor 102 performs control of the shape measuring apparatus 10 and various calculations including calculation of a three-dimensional shape (3D shape) of the surface to be measured of the measurement object W to generate shape data. The processing device 100 and the processor 102 are examples of a shape data generating section and an illumination controlling section according to the present invention. Specifically, the processor 102 performs: light emission control on the light source 20 and the illumination section 50; imaging control on the imaging section 30; or outputting of a control signal and the like to the drive mechanism 14 for control of movement of the optical unit 12 relative to the stage ST, in response to an operational input from the input device 108. The processor 102 switches between a point light source function and a surface light source function of the illumination section 50 in response to an operator's operational input from the input device 108 (manually) or in accordance with a mode setting and the like of the shape measuring apparatus 10 (automatically).

The memory 104 is a storage device used as a work region of the processor 102, and includes, for example, a random access memory (RAM).

The storage 106 is a storage device in which programs and data for controlling the shape measuring apparatus 10 and the processing device 100 are stored, and includes, for example, a hard disk drive (HDD) or a solid state drive (SSD). An image acquired from the imaging section 30 is stored in the storage 106.

The input device 108 is a device which receives an operational input from an operator of the shape measuring apparatus 10. The input device 108 includes, for example, a keyboard or a pointing device, such as a mouse or a touch panel.

The output device 110 includes a device (e.g., a liquid crystal display (LCD)) for displaying an image. For example, a graphical user interface (GUI) for operating the shape measuring apparatus 10 and the processing device 100, images, calculation results, and the like may be displayed on the output device 110.

### Illumination Section

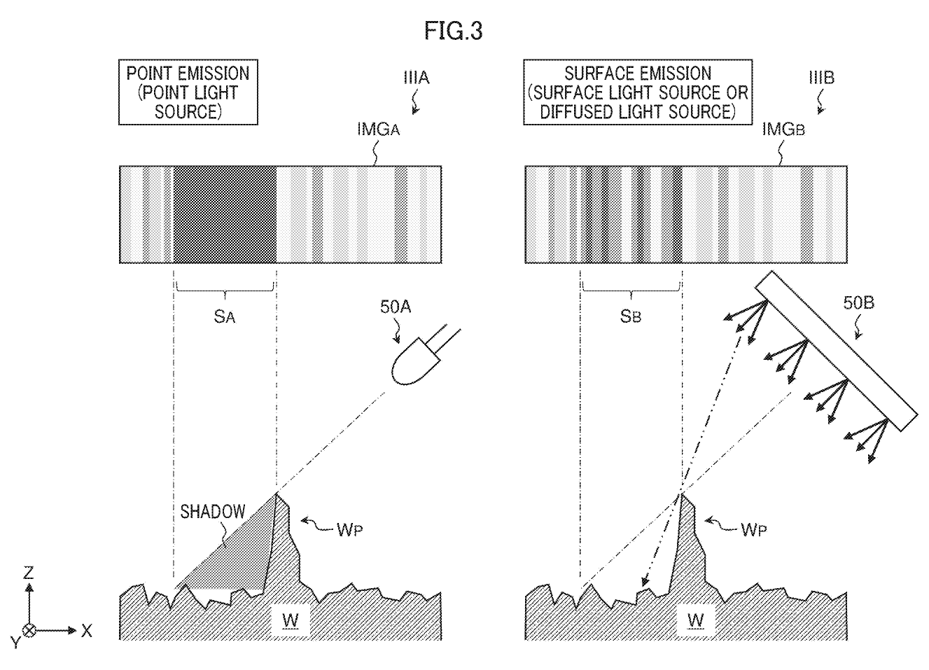

FIG. 3 is a chart for explaining a difference in how contrast information is obtained between a case where point emission is applied to the illumination section 50 and a case where surface emission is applied to the illumination section 50.

As shown in FIG. 3, in an example IIIA using point emission (a point light source), depending on the shape of the surface to be measured of the measurement object W, there are portions that are reached by illumination light traveling straight from the point light source 50A, and a shadow portion where the illumination light is blocked. For this reason, an image IMG_{A} captured by the imaging section 30 during use of the point light source 50A has a large difference in brightness between the portions that are reached by the illumination light and the shadow portion where the illumination light is blocked. In a case where there is a projecting portion W_{P} significantly protruding from the surface to be measured of the measurement object W, a region S_{A} from which no contrast information cannot be obtained due to the shadow portion increases in proportion to a height of the projecting portion W_{P} in the image IMG_{A}.

In contrast, in an example IIIB using surface emission (a surface light source or diffused light source), a shadow portion shielded by the projecting portion W_{P} from illumination light traveling straight from a surface light source 50B is illuminated with diffused light from the surface light source 50B. For this reason, in an image IMG_{B} captured by the imaging section 30 during use of the surface light source 50B, contrast information may be obtained for a region S_{B} corresponding to the shadow portion. Instead, the region S_{B} has a lower contrast due to the diffused light.

As described above, in the case where the surface to be measured is laterally illuminated using the point light source 50A, the illumination light traveling straight from the point light source 50A does not reach the shadow portion. This configuration has the advantage in that the contrast between light and shadow becomes high. This makes it easier to observe properties and a state of the surface to be measured of the measurement object W based on contrast information of the image IMG_{A}. For example, it is effective to use the point light source 50A with a large difference in brightness when visually searching for a position of the object to be measured on the surface to be measured. In addition, it becomes possible to perform measurement even in a case where measurement sensitivity is high, and reflectance of the measurement object W is low.

In the case of laterally illuminating the surface to be measured using the surface light source 50B, the contrast becomes lower than in the case of the point light source 50A. Therefore, since the contour (outline) tends to become blurred during observation of the properties of the surface to be measured of the measurement target object W based on the contrast information, this configuration is unsuitable for such observation. The configuration may be disadvantageous for visually searching for a position of the object to be measured on the surface to be measured. In a case where the reflectance of the measurement object W is low, the measurement sensitivity may be insufficient to perform measurement.

In the case of laterally illuminating the surface to be measured using the point light source 50A, the region S_{A} where no contrast information is obtained extends in proportion to the height of the projecting portion W_{P}, as in the above example. That is, a portion in which contrast information is lacking is likely to occur. With extension of a portion lacking contrast information, reliability of measurement may become lower to reduce accuracy of measurement. For example, in pixels near a deep shadow, the contrast information may be influenced by the shadow, which can introduce errors into the height information.

In the case of laterally illuminating the surface to be measured using the surface light source 50B, diffused light reaches the shadow portion where the light traveling straight is blocked. This configuration has the advantage in that a portion in which contrast information is missing is less likely to occur. This increases reliability of measurement and enhances accuracy of measurement. This also suppresses adverse effects of a deep shadow on adjacent pixels.

As described above, the point light source 50A and the surface light source 50B have a complementarity relation. For this reason, in the present embodiment, the shape measuring apparatus 10 uses the illumination section 50 capable of switching between the point light source 50A that performs point emission and the surface light source 50B that performs surface emission. This allows illumination according to properties or a measurement objective of the measurement object W.

Note that the present embodiment is not limited to a case where the illumination section 50 separately includes the point light source 50A and the surface light source 50B. The illumination section 50 may include a light source capable of switching between a point light source function and a surface light source function.

### Example 1 of Illumination Section

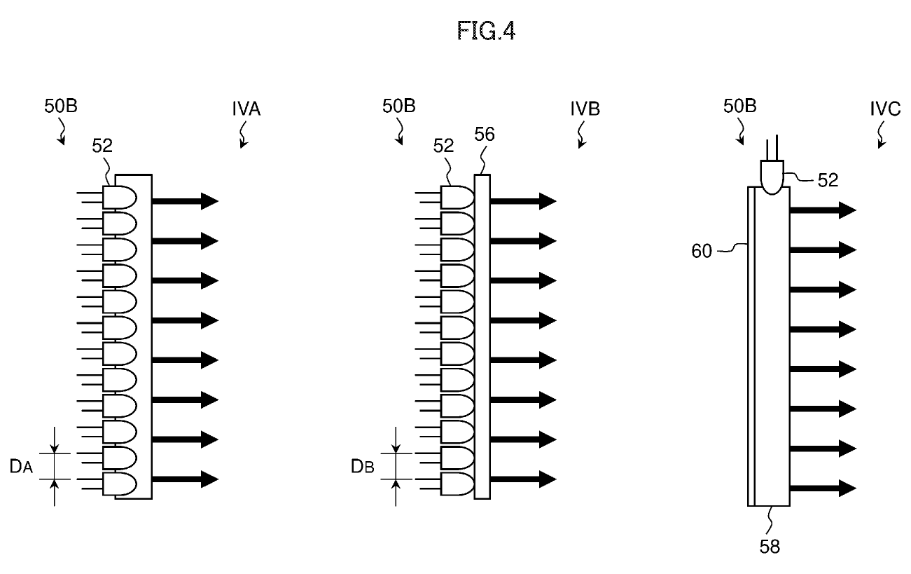

FIG. 4 is a side view showing an example of the surface light source 50B according to Example 1. Note that a board on which one or more LEDs 52 are mounted is not shown in FIG. 4.

The surface light source 50B shown in an example IVA of FIG. 4 is formed by densely arranging a plurality of small point light sources 52 side by side in the form of a plane (a substantially flat surface). The point light source 52 is, for example, a light emitting diode (LED). The LEDs 52 are fixed by being arranged in a substantially flat surface shape in a casing or a frame. The size and the density (a spacing D_{A}) of the LEDs 52 are set such that the LEDs 52 are sufficiently dense in relation to the characteristics (properties and state) of the surface to be measured of the measurement object W for uniform illumination with illumination light. For example, a spacing between the LEDs 52 (a second spacing) is made sufficiently short (for example, to a fraction thereof), relative to the representative size of the irregularities as an object to be measured on the surface to be measured, a characteristic spatial wavelength, or an average spacing between peaks. This allows uniform illumination of the surface to be measured.

The surface light source 50B shown in an example IVB of FIG. 4 includes: a plurality of LEDs 52; and a light-scattering member 56 which has a substantially flat surface shape and is arranged on exit-side surfaces of the LEDs 52. The light-scattering member 56 is, for example, either a transparent layer (such as a resin layer) with scattering particles adhered to its surface to scatter light, or a transparent layer (such as a resin layer) in which light-scattering particles are dispersed. Note that, in the example IVB, a spacing D_{B} between the LEDs 52 may be increased, as compared with the example IVA (spacing D_{A}). Thus, in the example IVB, the number of LEDs 52 per unit area may be made smaller than in the example IVA. In the example IVB, since light beams from the LEDs 52 are scattered by the light-scattering member 56, the surface to be measured may be uniformly illuminated.

The surface light source 50B shown in an example IVC of FIG. 4 includes a light guide 58 in a substantially flat surface shape, a reflector 60 which is provided at a surface opposite to an exit-side surface of the light guide 58, and the LEDs 52 that are provided at one end of the light guide 58.

The light guide 58 uniformly scatters light from the LEDs 52 in the form of a flat surface. For example, a light guiding panel (LGP) may be used as the light guide 58. Note that the number and arrangement of the LEDs 52 are adjusted in accordance with a flat surface shape and the like of the light guide 58 such that uniform illumination light is obtained.

The reflector 60 is, for example, a metal film with high reflectance, and reflects light scattered by the light guide 58 toward the exit-side surface.

In the example IVC, light beams from the LEDs 52 are scattered by the light guide 58 and reflected by the reflector 60. The surface to be measured may be uniformly illuminated.

Note that a shape in front view of the surface light source 50B is not particularly limited and may be appropriately selected in accordance with positional relationships with the optical unit 12, the stage ST, and the like. The surface light source 50B is not particularly limited as long as the surface light source 50B has a luminance distribution capable of uniformly illuminating the surface to be measured with diffused light.

The point light source 50A, may employ for example, a configuration including one point light source (LED). Alternatively, the point light source 50A may employ a configuration which includes a plurality of point light sources (LEDs) and in which the spacing between the LEDs is set sufficiently wide in relation to the characteristics of the surface to be measured (the spacing between the LEDs (a first spacing) is, for example, about several to ten times a typical size of irregularities as an object of measurement at the surface to be measured, a characteristic spatial wavelength, or an average spacing between crests). The first spacing here is set to be wider than the second spacing.

In Example 1, the point light source 50A and the surface light source 50B are arranged at different positions such that they may illuminate the imaging range (field of view) of the imaging section 30. Under the light emission control by the processing unit 100, the point light source 50A and the surface light source 50B may be selectively turned on. This allows easy switching between the point light source 50A and the surface light source 50B.

### Example 2 of Illumination Section

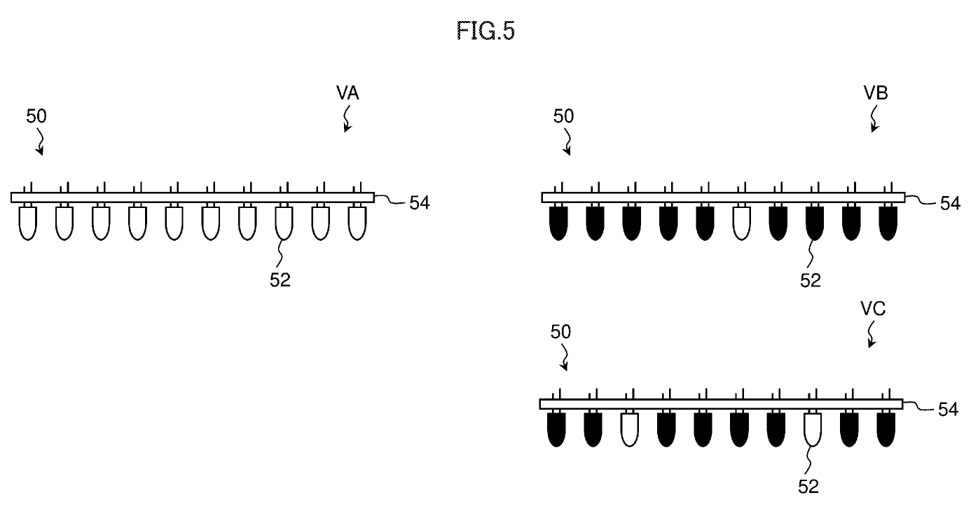

FIG. 5 is a side view showing an example of the illumination section 50 according to Example 2.

As shown in FIG. 5, the illumination section 50 according to Example 2 is formed by densely arranging a plurality of LEDs 52, each of which is a point light source, side by side on a board 54 having a planar (substantially flat) shape.

In a case where the illumination section 50 is made to function as a surface light source, all the LEDs 52 are turned on, as shown in an example VA. The size and the density (a second spacing) of the LEDs 52 are set, as in the example IVA according to Example 1, such that the LEDs 52 are sufficiently dense in relation to properties and a state of a surface to be measured of the measurement object W, so that the illumination light is uniformly emitted.

Note that, even in a case where the illumination section 50 is made to function as a surface light source, all the LEDs 52 need not be turned on, and only some of the LEDs 52 may be turned on. In this case, the LEDs 52 to be turned on may be selected so as to satisfy the condition on the second spacing for the LEDs 52.

In a case where the illumination section 50 is made to function as a point light source, only one of the LEDs 52 is turned on, as shown in an example VB. Alternatively, only some of the LEDs 52 may be turned on, as shown in an example VC. In the case of the example VC, the spacing (the first spacing) between the LEDs 52 to be turned on only needs to be sufficiently wide in relation to the characteristics of the surface to be measured, as in Example 1.

According to Example 2, a single light source may be used both as a point light source and a surface light source, and costs may be reduced. Additionally, Example 2 equalizes wavelength characteristics of a point light source and a surface light source. This allows elimination of color dependence and enhancement of consistency between measurement results from both the point light source and the surface light source.

### First Modification

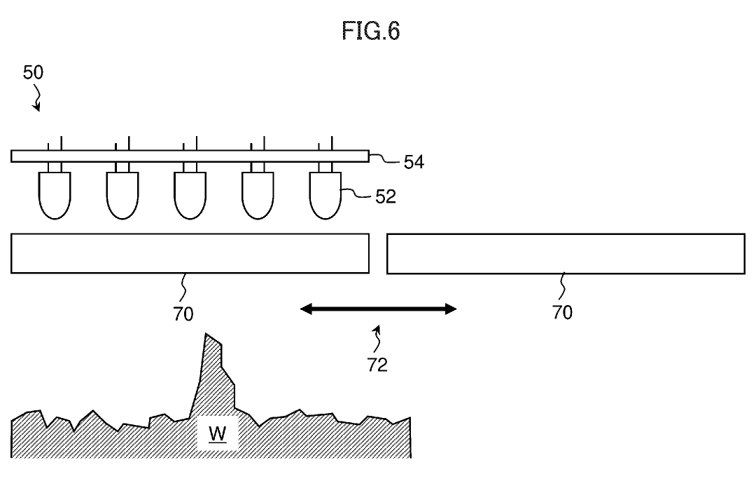

The illumination section 50 according to Example 2 may further include: a diffuser (diffuser plate) 70; and an insertion and removal mechanism (movable support structure) 72, as shown in FIG. 6.

The diffuser 70 is an optical element which substantially uniformly diffuses light from the LEDs 52 onto a surface to be measured. As the diffuser 70, for example, semitransparent resin, transparent resin or glass with a surface harshened by, e.g., sandblasting, a transparent layer (e.g., a resin layer) with a surface having a light-scattering particulate substance (scattering powder) attached thereto, or a transparent layer (e.g., a resin layer) in which particles for scattering light from the LEDs 52 are dispersed may be used. Note that the diffuser 70 desirably has uniform absorption and reflectance over a light wavelength range used in the illumination section 50.

The insertion and removal mechanism 72 is a device for inserting/removing the diffuser 70 into/from a space between the group of LEDs 52 mounted on the board 54 and a surface to be measured. The insertion and removal mechanism 72 includes, for example, a motor.

In the first modification shown in FIG. 6, the diffuser 70 is inserted between the group of LEDs 52 and the surface to be measured in a case where the illumination section 50 is made to function as a surface light source. The diffuser 70 is removed from between the group of LEDs 52 and the surface to be measured in a case where the illumination section 50 is made to function as a point light source.

In the first modification, since the diffuser 70 is used in the case where the illumination section 50 is made to function as a surface light source, the spacing between the LEDs 52 may be increased, as in the example IVB according to Example 1. The spacing between the LEDs 52 may be set to be, for example, about several to ten times any one of the following, on the surface to be measured: a typical size of irregularities to be measured, a characteristic spatial wavelength, or an average spacing between adjacent peaks. In this case, even when all the LEDs 52 are turned on in a state where the diffuser 70 is removed, the illumination section 50 may be made to function as the point light source.

According to the first modification, it is possible to achieve enhancement of spatial uniformity of a light amount, which is achieved in a case where a diffuser is inserted for use as a surface light source, while maintaining the feature for increasing contrast of a point light source.

In a case where there are one or a few LEDs 52, the diffuser 70 with high light diffusion performance (e.g., increased opacity or a large thickness) is needed to implement a surface light source. In this case, there is a great loss of light, and the more powerful LED 52 is needed. Since a plurality of LEDs 52 are provided in the present modification, the diffuser 70 with small light loss may be used, and the LED 52 with a lower light level may be adopted. The present modification is thus economical.

### Second Modification

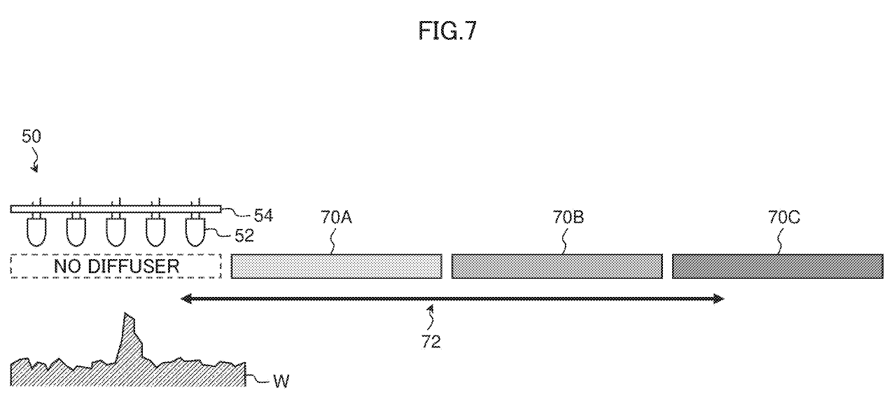

The diffuser 70 is not limited to one type. For example, a plurality of diffusers may be provided, as shown in FIG. 7. In this case, the insertion and removal mechanism 72 functions as a diffuser selecting mechanism for switching between a state with no diffuser and a state with a diffuser 70A, 70B, or 70C.

Here, the light diffusion performance (degree of diffusion) is such that the diffuser 70A < the diffuser 70B < the diffuser 70C. As a method for varying the light diffusion performance of the diffusers 70A to 70C, for example, the process of adjusting opacity or thicknesses of the diffusers, surface roughness of the diffusers, or the amounts of scattering powder to be attached to the diffusers or the amounts of scattering particles to be contained in the diffusers is conceivable.

According to the second modification, the degree of scattering may be adjusted in accordance with the measurement object W or a measurement objective. This allows measurement under best conditions with an optimized balance between measurement sensitivity and measurement accuracy.

### Third Modification

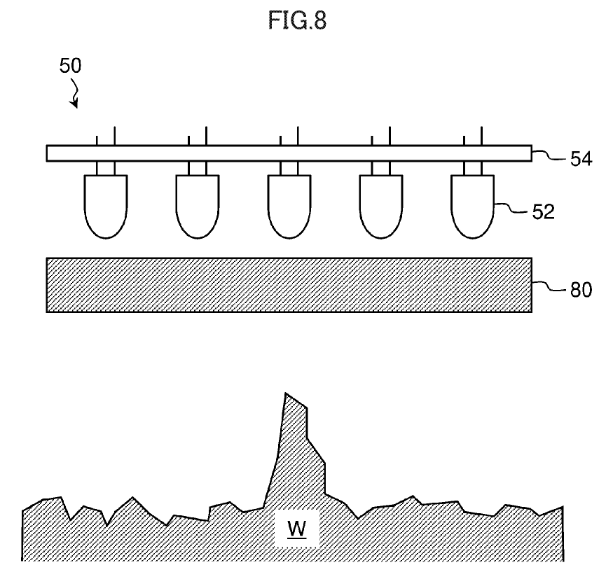

As a diffuser, a variable diffuser 80 with variable light diffusion performance (degree of diffusion) may be used, as shown in FIG. 8.

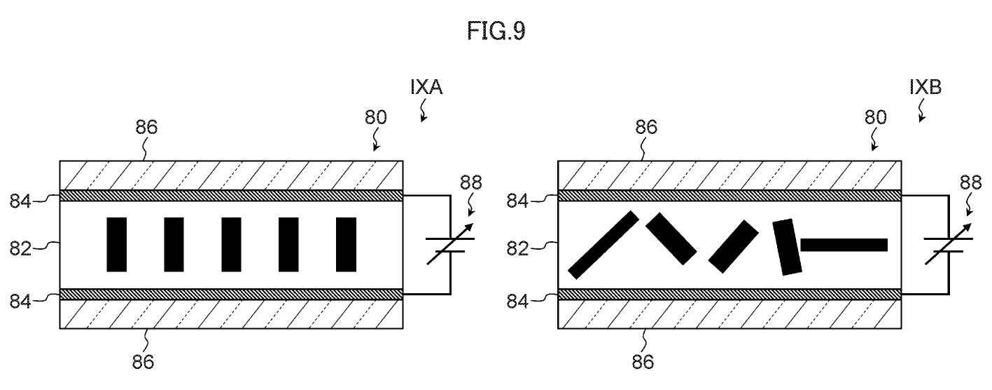

As shown in FIG. 9, the variable diffuser (variable diffuser plate) 80 includes a liquid crystal layer 82, transparent electrodes 84, transparent films 86, and a variable voltage source 88.

The liquid crystal layer 82 is a layer in which an orientational state of a liquid crystal is changed to vary optical characteristics when a voltage is applied. Transparency of the liquid crystal layer 82 may be changed by varying a voltage to be applied to the liquid crystal layer 82.

The transparent electrodes 84 are arranged as one pair so as to hold the liquid crystal layer 82 from both sides and are connected to the variable voltage source 88. The transparent electrodes 84 are made of a substance having electrical conductivity and optical transparency, such as indium tin oxide.

The transparent film 86 is a film having optical transparency which is formed on a surface on an opposite side of the transparent electrode 84 from the liquid crystal layer 82, and is, for example, a polyethylene terephthalate (PET) film.

The variable voltage source 88 is a power-supply device capable of changing the voltage to be applied to the liquid crystal layer 82 via the transparent electrodes 84.

In the variable diffuser 80, uniformity in orientation of the liquid crystal changes depending on the voltage applied to the liquid crystal layer 82. For example, as shown in an example IXA, the higher the applied voltage is, the more liquid crystal molecules are oriented in a same direction, and the higher the transparency of the liquid crystal layer 82 is. As shown in an example IXB, the lower the applied voltage is, the more liquid crystal molecules are oriented randomly, and the lower the transparency of the liquid crystal layer 82 is. For example, in a case where the illumination section 50 is switched to a point light source, transmittance of the variable diffuser 80 is maximized (to, e.g., 100%). In a case where the illumination section 50 functions as a surface light source, the transmittance of the variable diffuser 80 may be made lower than in a case where the illumination section 50 functions as a point light source. In this manner, the degree of light scattering may be adjusted.

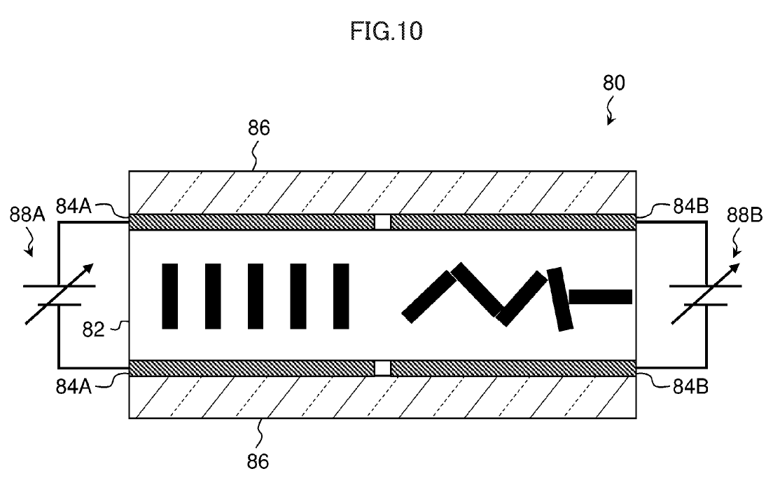

As shown in FIG. 10, the transparent electrodes 84 may be divided into two pairs of transparent electrodes 84A and 84B, and the two pairs of transparent electrodes 84A and 84B may be connected to separate (independent) variable voltage sources 88A and 88B. With this configuration, it is also possible to implement a degree of scattering varying depending on a position in the variable diffuser 80.

Note that a surface light source according to the present embodiment is not limited to one capable of completely uniform light emission. For example, to achieve necessary sensitivity, a device in which a degree of scattering is adjusted by optical elements (the light-scattering member 56, the light guide 58, the reflector 60, the diffuser 70 or the diffusers 70A to 70C, or the variable diffuser 80) used to scatter light when used as a surface light source, may be used as a surface light source.

### Shape Measuring Method

In the present embodiment, illumination according to, e.g., the properties or the measurement objective of the measurement object W is provided using the illumination section 50 capable of switching between the point light source 50A and the surface light source 50B illustrated above. Specifically, the point light source 50A is used to measure the characteristics of the surface to be measured in a case where a captured image of the surface to be measured of the measurement object W has a low contrast or to search for a position of an object of measurement on the surface to be measured of the measurement object W. In contrast, the surface light source 50B is used to acquire the characteristics of the surface to be measured with high accuracy.

According to the present embodiment, even in a case where a captured image of the surface to be measured of the measurement object W has a low contrast, a shortage of sensitivity may be suppressed, and a case where measurement is impossible may be reduced. Additionally, according to the present embodiment, when determining a position of an object of measurement on the surface to be measured of the measurement object W, it is possible to perform in-plane positioning with high accuracy and high reliability while suppressing decrease in measurement accuracy of the characteristics of the surface to be measured.

### First Example of Illumination Control

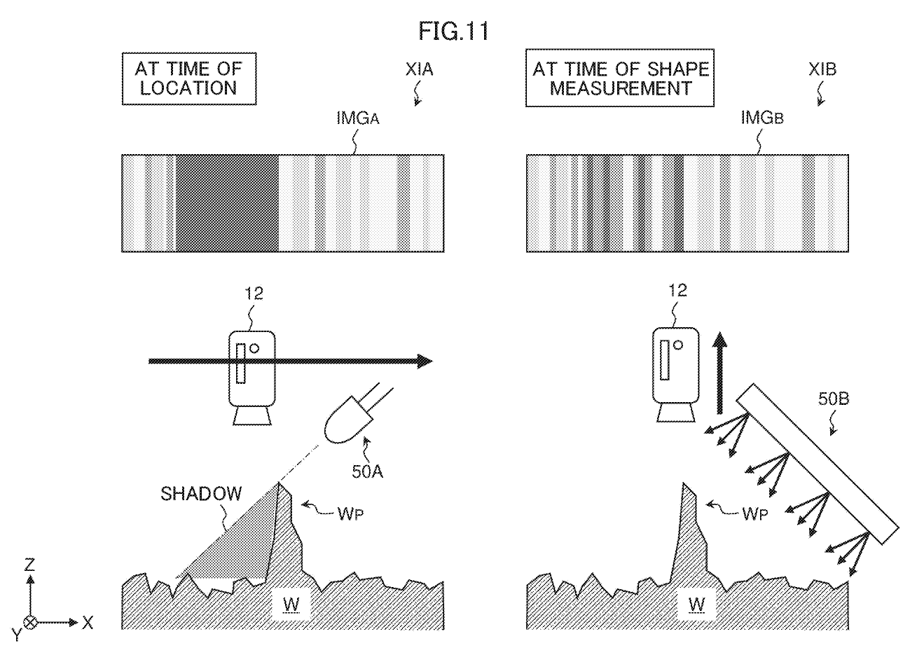

FIG. 11 is a chart for explaining a first example of illumination control.

To determine a position as an object of measurement on the surface to be measured of the measurement object W, it is necessary to capture an image of the surface to be measured and determine the position from image information of the image. Generally, because an object of measurement has a shape with a structure larger in a height direction than a planar shape therearound, and the image of the object of measurement is likely to form a high contrast (make a large shadow).

For this reason, in a case where the optical unit 12 is moved in the X and Y directions relative to the measurement object W to locate a position of the projecting portion W_{P} as an object of measurement, as shown in an example XIA of FIG. 11, the illumination section 50 is switched to the point light source 50A. By using the point light source 50A during the locating of the object, an image with relatively high contrast can be obtained. Thus, a position shadowed by the projecting portion W_{P} that is the object of measurement may be easily detected.

When the position of the projecting portion W_{P} is identified, the illumination section 50 is switched to the surface light source 50B, as shown in an example XIB of FIG. 11, and an image of the projecting portion W_{P} is captured while the optical unit 12 is made to scan in the Z direction, thereby performing shape measurement. By using the surface light source 50B during the shape measurement, it is possible to obtain contrast information for the portion shadowed by the projecting portion W_{P} that is the object of measurement, thereby facilitating measurement of a shape of the projecting portion W_{P}.

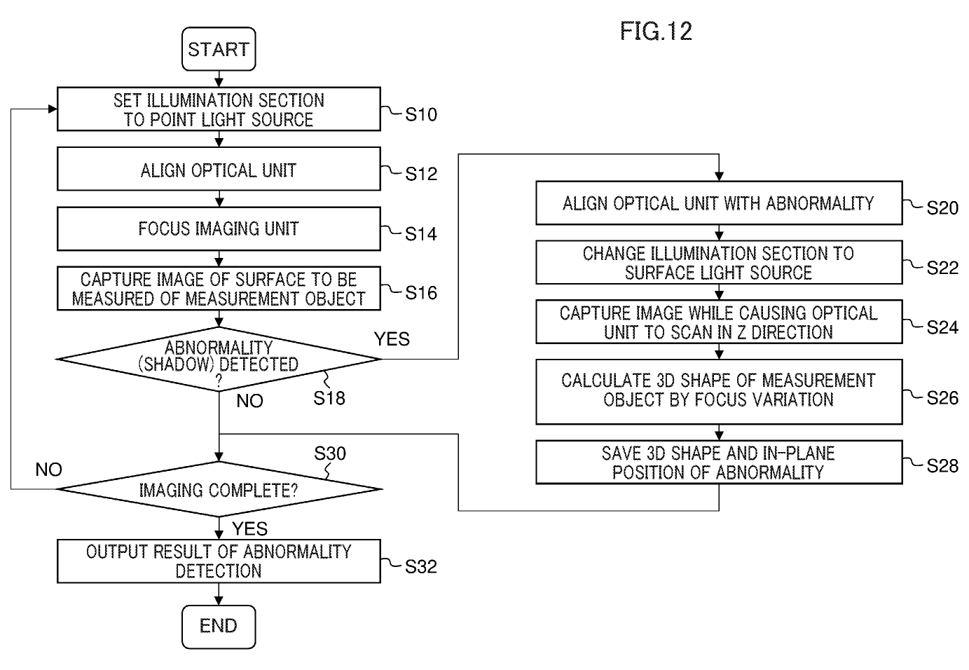

FIG. 12 is a flowchart showing the first example of illumination control. The illumination control shown in FIG. 12 is suitable for, for example, a case where the measurement object W is automatically inspected for an abnormality, such as a flaw or a foreign substance.

First, the illumination section 50 is set to the point light source 50A (step S10). The optical unit 12 is moved such that an imaging start position of the surface to be measured of the measurement object W placed on the stage ST falls within an imaging range of the imaging section 30 (step S12).

In step S10, switching between the point light source 50A and the surface light source 50B of the illumination section 50 may be manually performed or automatically performed. For example, in a case where a mode for abnormality inspection is set by the input device 108, the switching may be automatically performed by the processing device 100 (processor 102). Alternatively, an operator may manually perform the switching via an operation of the input device 108 or the like. Note that the order of steps S10 and S12 is not limited to the one in the example of FIG. 12.

The imaging section 30 is brought into focus on the surface to be measured (step S14), and an image of the surface to be measured of the measurement object W is captured by the imaging section 30 (step S16).

The image captured in step S16 is sent from the imaging section 30 to the processing device 100. The processing device 100 detects an abnormality (shadow) at the surface to be measured of the measurement object W (step S18).

In a case where the processing device 100 detects a low-intensity region with a predetermined number (ten, for example) or more of consecutive pixels lower in intensity than surrounding pixels, the processing device 100 determines that there is an abnormality (shadow) within the imaging range. The processing device 100 may determine, based on a relation between the imaging range and a position of the point light source 50A, that there is an abnormality near an end portion on the point light source 50A side of the low-intensity region, in a case where a low-intensity region with a predetermined number or more of pixels extending on a side opposite to the point light source 50A is detected. The number of pixels serving as a criterion for determining the presence or absence of abnormalities may be changed depending on a positional relation between the measurement object W and the point light source 50A and imaging section 30, such as an incident angle of light traveling straight from the point light source 50A with respect to the surface to be measured or an angle of the surface to be measured with respect to an optical axis of the imaging section 30. A size of an abnormality to be detected may be defined in advance, and the number of pixels serving as the criterion for abnormality detection may be changed in accordance with the size.

Determination of a low-intensity region may be performed based on a threshold for luminance difference from surrounding pixels which is set in accordance with, for example, luminance of the point light source 50A, the properties (e.g., the type or reflectance of the surface to be measured) of the measurement object W, and a positional relation between the point light source 50A and the surface to be measured. In the determination of a low-intensity region, for example, an image of the surface to be measured may be subjected to binarization or conversion into a multivalued representation.

In a case where an abnormality is detected (YES in step S18), preparations for abnormality measurement (steps S20 and S22) are performed. The optical unit 12 is driven, and the imaging range of the imaging section 30 is aligned with a region including the detected abnormality (step S20). In step S20, the alignment may be performed, for example, such that the detected abnormality (e.g., an end portion of a shadow closer to the point light source 50A) is located in the middle of the imaging range of the imaging section 30. The illumination section 50 is changed from the point light source 50A to the surface light source 50B (step S22). Note that the order of steps S20 and S22 is not limited to the example of FIG. 12. Settings (e.g., a magnification) of the imaging section 30 may be changed.

Images of the surface to be measured are captured by the imaging section 30 while the optical unit 12 is made to scan in the Z direction (step S24). The processing device 100 detects, for each set of corresponding pixels of the captured images, a Z position with a maximum contrast and calculates a three-dimensional shape of the region including the abnormality of the surface to be measured (step S26). The processing device 100 stores (saves) the calculated three-dimensional shape and an in-plane position (X- and Y-coordinates) of the abnormality in the storage 106 (step S28).

The optical unit 12 is moved in the X and Y directions relative to the surface to be measured to repeat abnormality sensing at the surface to be measured. When image capturing on the surface to be measured is completed (YES in step S30), the processing device 100 outputs a result of abnormality detection to the output device 110 (step S32). In step S32, the processing device 100 causes the output device 110 to display, for example, presence or absence of an abnormality, and a shape, a position and the like of the abnormality, if any.

Note that, in steps S10 to S30, the illumination section 50 is moved in line with scanning in the X and Y directions by the optical unit 12 to perform image capturing. The illumination section 50 may follow movement of the optical unit 12. Since it suffices for the imaging range of the imaging section 30 to be illuminated with illumination light from the illumination section 50 (the point light source 50A and the surface light source 50B), the illumination section 50 may be moved once, for example, each time scanning in the X and Y directions by the optical unit 12 is performed several times.

According to the first example, it is possible to easily perform location of an object of measurement having a structure large in the height direction (Z direction) at the surface to be measured and a shape.

### Second Example of Illumination Control

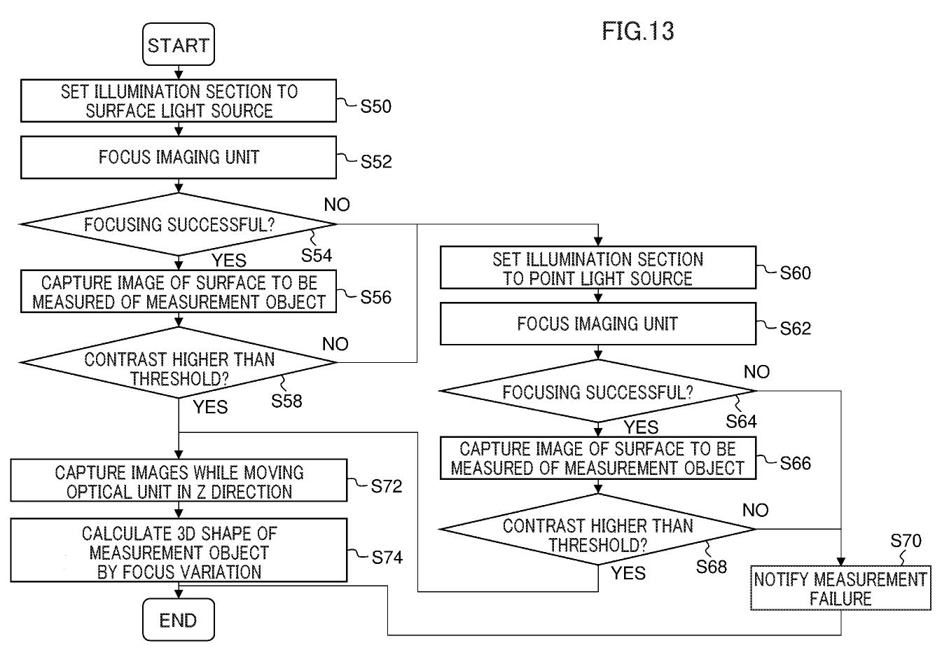

FIG. 13 is a flowchart showing a second example of the illumination control. The illumination control shown in FIG. 13 is suitable for a case where a low-contrast workpiece having a low-contrast surface to be measured is measured. The low-contrast workpiece here refers to, for example, rubber (particularly a black one), resin, a low-reflectance material, a black (matte black) material, a transparent material, or a semitransparent material.

First, the illumination section 50 is set to the surface light source 50B (step S50). In step S50, switching between the point light source 50A and the surface light source 50B of the illumination section 50 may be manually performed or automatically performed. For example, in a case where a mode for detecting the type of the measurement object W is set by the input device 108, the switching may be automatically performed by the processing device 100 (processor 102). Alternatively, the operator may manually perform the switching via an operation of the input device 108 or the like.

The imaging section 30 is brought into focus on the surface to be measured (step S52). In a case where the imaging section 30 is successfully brought into focus on the surface to be measured (YES in step S54), an image of the surface to be measured of the measurement object W is captured by the imaging section 30 (step S56).

The image captured in step S56 is sent from the imaging section 30 to the treatment device 100. The processing device 100 calculates contrast in the image captured in step S56 and performs determination.

In a case where the image captured in step S56 is higher than a threshold (YES in step S58), measurement of the surface to be measured is executed (steps S72 and S74). That is, images of the surface to be measured are captured by the imaging section 30 while moving the optical unit 12 in the Z direction (step S72). The processing device 100 detects, for each set of corresponding pixels of the captured images, a Z position with a maximum contrast and calculates a three-dimensional shape of a region including an abnormality of the surface to be measured (step S74). The processing device 100 stores the calculated three-dimensional shape in the storage 106. Note that the processing device 100 may output the calculated three-dimensional shape to the output device 110.

On the other hand, in a case where the imaging section 30 cannot be brought into focus on the surface to be measured with the surface light source 50B (NO in step S54) or in a case where the image captured in step S56 is equal to or less than the threshold (NO in step S58), the flow advances to step S60.

In step S60, the illumination section 50 is set to the point light source 50A, and the imaging section 30 is brought into focus on the surface to be measured (step S62). In a case where the imaging section 30 is successfully brought into focus on the surface to be measured (YES in step S64), an image of the surface to be measured of the measurement object W is captured by the imaging section 30 (step S66).

In a case where the image captured in step S66 is higher than the threshold (YES in step S68), measurement of the surface to be measured is executed (steps S72 and S74).

On the other hand, in a case where the imaging section 30 cannot be brought into focus on the surface to be measured even with the point light source 50A (NO in step S64) or in a case where the image captured in step S66 is equal to or less than the threshold (NO in step S68), the processing device 100 notify the use of measurement failure via the output device 110 (step S70) and ends the process.

According to the second example, switching to the point light source 50A is performed in a case where focusing fails with the surface light source 50B or in a case where a contrast value is low. This allows automatic switching to illumination suitable for measurement of a low-contrast workpiece.

Note that, in the second example, whether measurement is possible is determined by calculating contrast of a captured image; however, the present invention is not limited to this example. For example, whether measurement is possible may be determined based on a result of actual scanning in the Z direction and calculation of a three-dimensional shape. For example, in a case where the proportion of pixels, for which calculation is impossible due to lack of sensitivity, exceeds a threshold, the illumination section 50 may be switched.

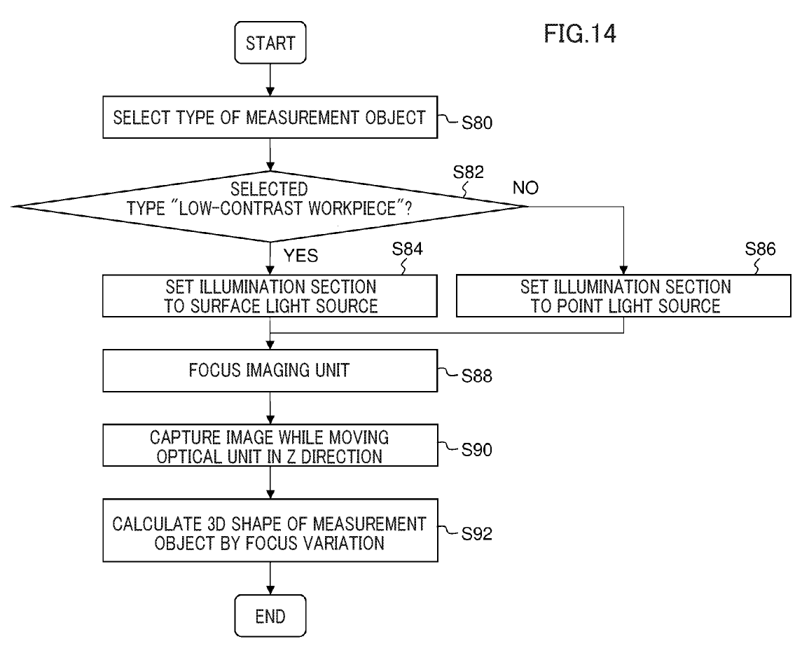

The illumination section 50 may be switched in response to an input from the operator. FIG. 14 is a flowchart showing a modification of the second example of the illumination control.

In the example shown in FIG. 14, an input selecting the type of the measurement object W is first received from the operator via the input device 108 (step S80). In step S80, for example, an input making a choice between two options as to whether or not the measurement object W is a low-contrast workpiece may be received or an input of the material, color, or the like of the measurement object W may be received.

In a case where the type of the measurement object W selected in step S80 is a low-contrast workpiece (YES in step S82), the illumination section 50 is set to the surface light source 50B (step S84). On the other hand, in a case where the type of the measurement object W selected in step S80 is not a low-contrast workpiece (NO in step S82), the illumination section 50 is set to the point light source 50A (step S86).

The imaging section 30 is brought into focus on the surface to be measured (step S88) to execute measurement of the surface to be measured (steps S90 and S92). Steps S90 and S92 are the same as steps S72 and S74 in FIG. 13, and a description thereof will be omitted.

According to the present modification, it is possible to switch to illumination suitable for measurement of a low-contrast workpiece in accordance with an input selecting the type of the measurement object W from the operator.

### Third Example of Illumination Control

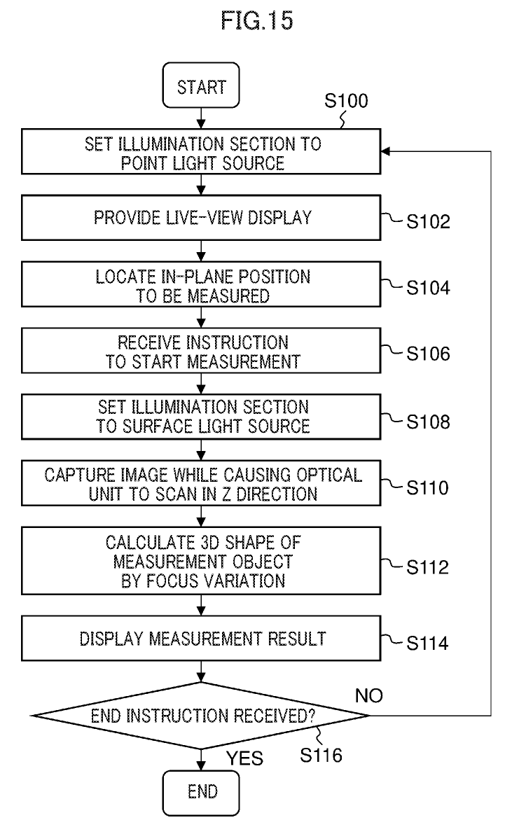

Switching of the illumination section 50 is not limited to the above-described examples, and may also be performed to, for example, aid the operator in measurement work. FIG. 15 is a flowchart showing a third example of the illumination control.

First, the illumination section 50 is set to the point light source 50A (step S100). An image of the surface to be measured is captured by the imaging section 30, and a live-view image of the surface to be measured is displayed on the output device 110 (step S102).

In step S100, switching between the point light source 50A and the surface light source 50B of the illumination section 50 may be manually performed or automatically performed. For example, in a case where a mode for location by the operator is set by the input device 108, switching may be automatically performed by the processing device 100 (processor 102). Alternatively, the operator may manually perform the switching via an operation of the input device 108 or the like.

In accordance with an instruction from the operator input via the input device 108, the optical unit 12 is moved in the X and Y directions, and an in-plane position (measurement start portion) as an object of imaging at the surface to be measured is located. The optical unit 12 is moved such that the measurement start position falls within the imaging range of the imaging section 30 (step S104).

When an instruction to start measurement is received from the operator via the input device 108 (step S106), the illumination section 50 is set to the surface light source 50B (step S108) to execute measurement of the surface to be measured (steps S110 to S114). That is, images of the surface to be measured are captured by the imaging section 30 while the optical unit 12 is made to scan in the Z direction (step S110). The processing device 100 detects, for each set of corresponding pixels of the captured images, a Z position with a maximum contrast and calculates a three-dimensional shape of a region including an abnormality of the surface to be measured (step S112). The processing device 100 stores the calculated three-dimensional shape in the storage 106. Note that the processing device 100 may output the calculated three-dimensional shape to the output device 110 (step S114).

When an instruction to end measurement is received from the operator via the input device 108 (YES in step S116), the measurement ends.

According to the third example, by using the point light source 50A, a high-contrast image can be obtained during observation of the surface to be measured by the operator. Thus, information on a position of an object of measurement and the surface to be measured may be displayed in an easy-to-see form. Additionally, by using the surface light source 50B during measurement, a decrease in measurement accuracy and a loss of information due to shadows may be suppressed.

Note that the shape measuring apparatus 10 according to the present embodiment may be configured to be capable of selecting a desired mode from among the modes according to the first to third examples of the illumination control.

### REFERENCE SIGNS LIST

10: shape measuring apparatus, 12: optical unit, 14: drive mechanism, 16: scale, 20: light source, 22: lens, 24: beam splitter, 26: condenser lens, 28: condenser lens, 30: imaging section, 50: illumination section, 50A: point light source, 50B: surface light source, 52: LED, 54: board, 56: light-scattering member, 58: light guide, 60: reflector, 70, 70A, 70B, 70C: diffuser, 72: insertion and removal mechanism, 80: variable diffuser, 82: liquid crystal layer, 84: transparent electrode, 86: transparent film, 88: variable voltage source, 100: processing device, 102: processor, 104: memory, 106: storage, 108: input device, 110: output device

What is claimed is:

1. A shape measuring apparatus comprising:
an optical unit having an imaging section configured to capture an image of a surface to be measured of a measurement object;
a drive mechanism configured to move the optical unit relative to the surface to be measured in a direction along an optical axis of the imaging section;
an illumination section configured to laterally illuminate the surface to be measured and capable of switching between a point light source function and a surface light source function;
a shape data generating section configured to generate shape data indicating a shape of the surface to be measured based on captured images obtained by repeatedly capturing images with the imaging section while the optical unit is relatively moved; and
an illumination controlling section configured to switch the illumination section that laterally illuminates the surface to be measured, between the point light source function and the surface light source function.

2. The shape measuring apparatus according to claim 1, wherein
the illumination section includes a plurality of planarly arranged point light sources,
in a case where the illumination section is set to perform the point light source function, one point light source of the plurality of point light sources is made to emit light, or two or more point light sources spaced apart by a distance equal to or more than a first spacing are made to emit light, and
in a case where the illumination section is set to perform the surface light source function, all of the plurality of point light sources are made to emit light, or two or more point light sources spaced apart by a distance equal to or less than a second spacing narrower than the first spacing, are made to emit light.

3. The shape measuring apparatus according to claim 2, wherein
the illumination section includes
a diffuser configured to diffuse light beams from the plurality of point light sources onto the surface to be measured, and
an insertion and removal mechanism configured to insert and remove the diffuser into and from a space between the plurality of point light sources and the surface to be measured, and
the illumination controlling section removes the diffuser in a case where the illumination section is set to perform the point light source function, and inserts the diffuser in a case where the illumination section is set to perform the surface light source function.

4. The shape measuring apparatus according to claim 3, wherein the illumination section includes a plurality of diffusers different in light diffusion performance.

5. The shape measuring apparatus according to claim 2, wherein
the illumination section includes a variable diffuser, light diffusion performance of which is changeable, and
in a case where the illumination section is set to perform the surface light source function, the illumination controlling section sets transmittance of the variable diffuser lower than in a case where the illumination section is set to perform the point light source function.

6. The shape measuring apparatus according to claim 1, wherein the illumination controlling section switches the illumination section to the point light source function when locating a position of an object of measurement.

7. The shape measuring apparatus according to claim 6, wherein the illumination controlling section switches the illumination section to the surface light source function in measuring a shape at the position of the object of measurement.

8. The shape measuring apparatus according to claim 6, comprising
an output device configured to display a live-view image captured by the imaging section when locating the position of the object of measurement.

9. The shape measuring apparatus according to claim 1, wherein the illumination controlling section switches the illumination section to the point light source function in a case where the surface light source function fails to bring the imaging section into focus on the surface to be measured, or in a case where a contrast value of an image captured by the imaging section is equal to or less than a threshold.

10. The shape measuring apparatus according to claim 1, wherein the illumination controlling section switches between the point light source function and the surface light source function in accordance with an input selecting a type of the measurement object.

11. A shape measuring method comprising:
generating shape data indicating a shape of a surface to be measured of a measurement object, based on captured images obtained by repeatedly capturing images of the surface to be measured with an imaging section while an optical unit, having the imaging section, is moved relative to the surface to be measured in a direction along an optical axis of the imaging section; and
switching an illumination section that laterally illuminates the surface to be measured, between a point light source function and a surface light source function.
